(19) United States
(12) Patent Application Publication
(10) Pub. No.: US 2022/0302843 A1
(43) Pub. Date: Sep. 22, 2022

(54) AUXILIARY VOLTAGE SUPPLY FOR POWER CONVERTER AND USE THEREOF IN VEHICLES

(71) Applicant: Rolls-Royce Deutschland Ltd & Co KG, Blankenfelde-Mahlow (DE)

(72) Inventor: Christoph Bernd MARXGUT, München (DE)

(21) Appl. No.: 17/638,326

(22) PCT Filed: Aug. 19, 2020
(86) PCT No.: PCT/EP2020/073183

§ 371 Date: Feb. 25, 2022

(30) Foreign Application Priority Data
Aug. 30, 2019 (DE) 10 2019 213 156.5

(51) Int. Cl. H02M 3/335; H02M 1/00; H02M 7/483; B64D 27/24; B64D 41/00

(52) U.S. Cl. CPC H02M 3/33569; H02M 1/0006; H02M 7/4837; B64D 27/24; B64D 41/00; H02P 27/06

(57) ABSTRACT

A circuit arrangement for generating an auxiliary DC voltage is disclosed. The circuit arrangement includes a half bridge circuit outputting a load current, which half bridge circuit converts a DC voltage to an AC voltage, and at least two intermediate circuit capacitors arranged on the input side, in series parallel to the half bridge circuit. The circuit arrangement further includes an auxiliary voltage generating unit supplied with electrical energy by one of the intermediate circuit capacitors, and which is configured to generate an auxiliary DC voltage of less than or equal to 48V. The disclosure also relates to an associated method for generating an auxiliary DC voltage and to a power converter and a vehicle having such a circuit arrangement.

The present patent document is a § 371 nationalization of PCT Application Serial No. PCT/EP2020/073183, filed Aug. 19, 2020, designating the United States, which is hereby incorporated by reference, and this patent document also claims the benefit of German Patent Application No. 10 2019 213 156.5, filed Aug. 30, 2019, which is also hereby incorporated by reference.

### TECHNICAL FIELD

The disclosure relates to a circuit arrangement for generating an auxiliary DC voltage for a power converter. The disclosure also relates to a power converter including a circuit arrangement of this type, and to a vehicle including a power converter of this type. The disclosure additionally relates to an associated method for generating an auxiliary DC voltage.

### BACKGROUND

Applications requiring high availability or a very low probability of failure of power electronic power converters in high-voltage technology (>1 kV) present a particular challenge for the design because these requirements are demanding from both a technical (weight, efficiency, volume, complexity, etc.) and an economic standpoint.

A central point here is to provide the auxiliary voltage supply of the power converter because the function of the power converter is dependent on the availability of the auxiliary voltage supply.

In aviation applications, auxiliary voltage supplies are embodied with multiple redundancy in order that the failure of one auxiliary voltage branch may be mitigated by other paths. These are either supplied by AC/DC converters from the on-board electrical system (e.g., 115 V/400 Hz) or are supplied by battery systems (e.g., 28 V/DC). One disadvantage of these embodiments is the complexity entailed by the redundancy. Additionally, the weight of the entire auxiliary voltage supply increases as a result, which is disadvantageous particularly in aviation.

The prior art as disclosed in the present application US 2012/0218795 A1, for example, discloses in the context of power converters a “flying capacitor topology”, which constitutes a known multilevel topology in power electronics.

In another case, a DC input voltage is converted into an AC output voltage for supplying a phase of a three-phase electrical machine. For this purpose, the input voltage, buffered by two link circuit capacitors connected in series, is fed to a half-bridge circuit. The half-bridge circuit is formed by the first branch and the second branch. The half-bridge circuit converts the DC voltage into an AC voltage.

As may be discerned, unlike in conventional topologies, the half-bridge circuit is not constituted by two switching elements, in the case of which the center point is fed to a load, but rather by four switching elements S₁ to S₄. The switching elements S₁ to S₄ may be semiconductor components.

The first and the second switching element S₁ and S₂, which switch simultaneously, form the first branch A₁ and the third and the fourth switching element S₃ and S₄, which switch simultaneously, form the second branch A₂. The series connection of the switching elements S₁ and S₂ and respectively S₃ and S₄ enables the input voltage V¹ to be divided between in each case two switching elements S₁ and S₂ and respectively S₃ and S₄ of the corresponding branches A₁ and respectively A₂. Accordingly, it is possible to use switching elements S₁ to S₄ with a rated voltage approximately equal to half the input voltage V¹. In this case, it is only necessary to provide that the voltage division of the two switching elements S₁ and S₂ and respectively S₃ and S₄ is equal in each case, since otherwise one or more of the switching elements S₁ to S₄ is overloaded in terms of voltage and/or in terms of current, as a result of which the entire circuit arrangement 1 may be destroyed.

In order to achieve as uniform a division of the input voltage V¹ as possible, a flying capacitor 3 is arranged in parallel on the input side at the half-bridge circuit 2 and keeps the voltages of the switching elements S₁ and S₂ and respectively S₃ and S₄ virtually constant even during the commutation period. As a result, a large voltage unbalance cannot form in the case of non-identical switching on and off times of the switching elements S₁ and S₂ and respectively S₃ and S₄ in the branches A₁ and respectively A₂.

### SUMMARY

It is an object of the disclosure to specify a solution for an auxiliary voltage supply for power converters which is less complex and has less weight by comparison with the prior art.

The scope of the present disclosure is defined solely by the appended claims and is not affected to any degree by the statements within this summary. The present embodiments may obviate one or more of the drawbacks or limitations in the related art

A first aspect of the disclosure consists in the fact that an inherently necessary capacitor of a power converter is used for supplying an auxiliary voltage generating unit. This is easily possible particularly in the case of topologies, as illustrated in FIG. 1, because a plurality of link circuit capacitors which have not applied the full link circuit voltage are used here. The switches of the auxiliary voltage generating unit and the insulation thus do not have to be designed for the entire link circuit voltage, which reduces the costs, the weight and the complexity of the power converter.

The disclosure provides a circuit arrangement for generating an auxiliary DC voltage. The circuit arrangement includes a half-bridge circuit, which outputs a load current and converts a DC voltage into an AC voltage, and at least two link circuit capacitors arranged in series on the input side in parallel with the half-bridge circuit. The circuit arrangement also includes an auxiliary voltage generating unit supplied with electrical energy by one of the link circuit capacitors and configured to generate an auxiliary DC voltage of less than or equal to 48 V.

In one development, the half-bridge circuit has, in each of the two branches, at least two switching elements arranged in series, wherein a flying capacitor is connected in parallel with respectively corresponding switching elements of the two branches.

In one development, the voltage at the flying capacitor may be controllable by the choice of the switching times of the switching elements.

In a development, the auxiliary voltage generating unit has a full-bridge circuit, a transformer supplied by the full-bridge circuit, and a rectifier circuit supplied by the transformer.

The disclosure also provides a power converter, (e.g., an inverter), that includes a circuit arrangement as disclosed herein.

Inverter denotes a power converter which generates an AC voltage from a DC voltage, the frequency and amplitude of said AC voltage being varied. An output AC voltage is generated from an input DC voltage by a DC voltage link circuit and clocked semiconductor switches.

The disclosure also provides a vehicle, (e.g., an aircraft), that includes a power converter as disclosed herein for an electric or hybrid electric drive.

A vehicle is understood to mean any type of locomotion or transport, whether manned or unmanned. An aircraft is a flying vehicle.

In a further configuration, the vehicle includes an electric motor supplied with electrical energy by the power converter, and a propeller that may be set in rotation by the electric motor.

The disclosure also provides a method for generating an auxiliary DC voltage, including: a half-bridge circuit, which outputs a load current and converts a DC voltage into an AC voltage, and at least two link circuit capacitors arranged in series on the input side in parallel with the half-bridge circuit, wherein an auxiliary voltage generating unit is supplied with electrical energy from one of the link circuit capacitors, wherein the auxiliary DC voltage of less than or equal to 48 V is generated.

Further special features and advantages of the disclosure become clear from the following explanations of an exemplary embodiment with reference to schematic drawings.

### BRIEF DESCRIPTION OF THE DRAWINGS

FIG. 1 depicts a circuit diagram of a circuit arrangement in accordance with the prior art.

FIG. 2 depicts a block diagram of a circuit arrangement with auxiliary voltage generating unit.

FIG. 3 depicts a circuit diagram of a circuit arrangement with auxiliary voltage generating unit.

FIG. 4 depicts a block diagram of a power converter.

FIG. 5 depicts an aircraft including a power converter.

### DETAILED DESCRIPTION

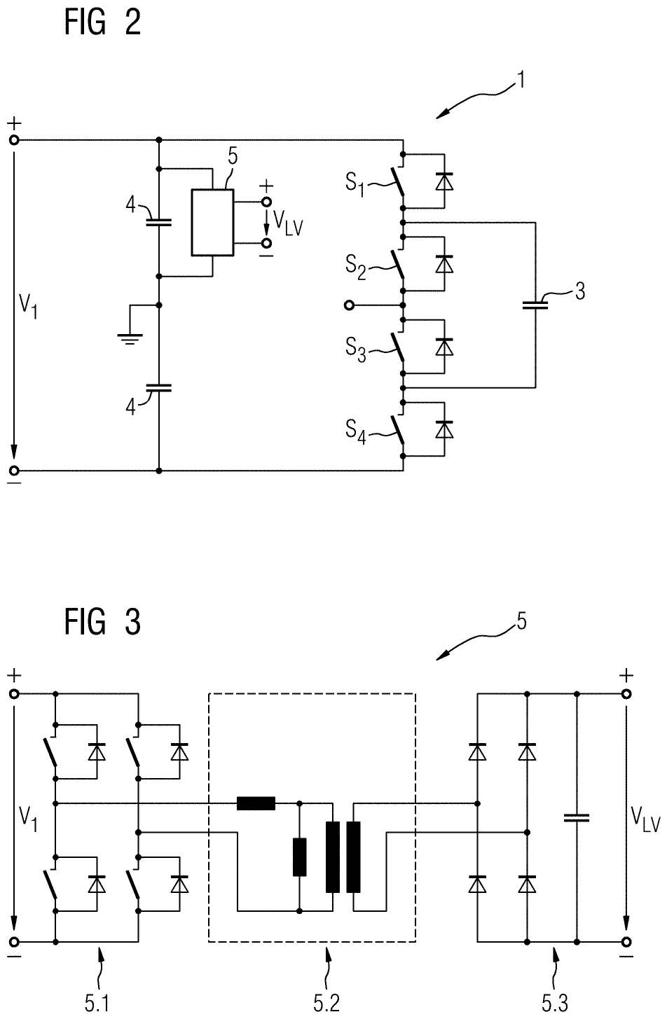

FIG. 2 depicts the auxiliary voltage architecture on the basis of the example of a quasi-2L converter (only one phase is illustrated, however). In this case, the voltage at the flying capacitor 3 is controlled by the offset of the switching on times of the switching elements S₁ to S₄; the flying capacitor 3 is required for stabilizing the switching transients and simultaneously forms the input capacitor of the auxiliary voltage generating unit 5.

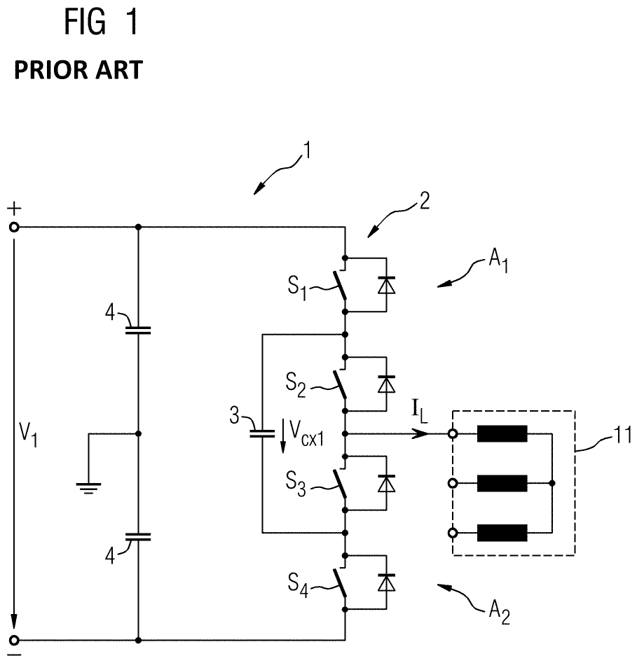

FIG. 2 depicts the circuit arrangement 1 in accordance with FIG. 1 including a half-bridge circuit 2 and two link circuit capacitors 4 connected in series, wherein the auxiliary voltage generating unit 5 is arranged in parallel with one of the two link circuit capacitors 4 and is supplied by the electrical energy stored in the link circuit capacitor 4. The auxiliary voltage generating unit 5 generates an auxiliary DC voltage V_{LV} of less than or equal to 48 V.

FIG. 3 depicts one example of a circuit of the auxiliary voltage generating unit 5. A full-bridge circuit 5.1 is situated on the input side and generates an AC voltage from an input DC voltage. The AC voltage is fed to a transformer 5.2 for the purpose of potential isolation. On the output side, a rectifier circuit 5.3 is connected to the transformer 5.2. The auxiliary DC voltage V_{LV} is then available at the output of the rectifier circuit 5.3.

The topology of the auxiliary voltage generating unit 5 may be chosen and configured by the designer freely, in principle, but must provide the transformer 5.2 for the purpose of voltage isolation on account of the potential at the flying capacitor 3.

A major advantage of this architecture is that the switches of the full-bridge circuit are not loaded with the full link circuit voltage (>1 kV) but rather with the maximum voltage at one of the link circuit capacitors 4, which is significantly smaller depending on the number of capacitors. Switches with the same voltage requirement as in the power circuit (switching elements S₁ to S₄) may thus be incorporated (but with a lower current requirement).

In this context, however, it may also already be predicted that the flyback topology that is very popular for auxiliary voltage converters is not optimal here because said topology, with respect to the input voltage, additionally applies the transformed output voltage to the switches.

For the case of a redundant auxiliary voltage architecture, either the magnetic circuit of the transformer may be additionally tapped or the energy is supplied via diodes to the capacitor at the output. With the architecture, in any case, a supply path from high voltage to low voltage would have been produced in a suitable manner, which has been possible hitherto only by additional high-voltage auxiliary converters.

The concept presented here may be used either as a “stand-alone” auxiliary voltage supply for AC/DC, DC/AC, and DC/DC (quasi) multilevel power converters, or as an additional auxiliary voltage branch for critical applications, such as in aviation, for example.

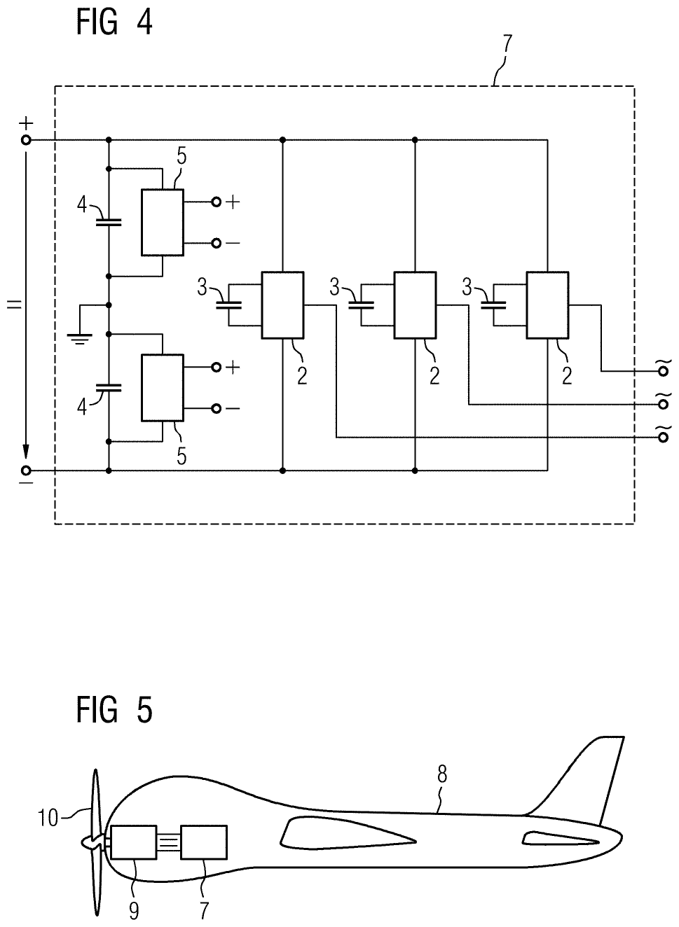

FIG. 4 depicts a block diagram of a DC/AC power converter 7, (e.g., of an inverter), which includes a circuit arrangement for generating a three-phase AC voltage. For this purpose, a half-bridge circuit 2 together with flying capacitor 3 are embodied for each phase. The half-bridge circuit 2 is supplied with DC voltage by two link circuit capacitors 4 connected in series. Each link circuit capacitor 4 supplies a respective auxiliary voltage generating unit 5.

FIG. 5 depicts an electric or hybrid electric aircraft 8, (e.g., an airplane), which includes a power converter 7 in accordance with FIG. 4, which supplies an electric motor 9 with electrical energy. The electric motor 9 drives a propeller 10. Both are part of an electrical thrust-generating unit. A power converter 7 may also be part of an on-board electrical system.

Although the disclosure has been described and illustrated more specifically in detail by the exemplary embodiments, the disclosure is not restricted by the disclosed examples and other variations may be derived therefrom by a person skilled in the art without departing from the scope of protection of the disclosure.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

### LIST OF REFERENCE SIGNS

1 Circuit arrangement
2 Half-bridge circuit
3 Flying capacitor
4 Link circuit capacitor
5 Auxiliary voltage generating unit
5.1 Full-bridge circuit
5.2 Transformer
5.3 Rectifier circuit
7 Power converter
8 Aircraft
9 Electric motor
10 Propeller
11 Electrical machine
A₁ First branch
A2 Second branch
I_{L} Load current
S₁ First switching element
S₂ Second switching element
S₃ Third switching element
S₄ Fourth switching element
V_{cxl} Voltage at the flying capacitor 3
V₁ Input voltage
V_{LV} Auxiliary DC voltage

1. A circuit arrangement for generating an auxiliary DC voltage, the circuit arrangement:
a half-bridge circuit configured to output a load current and convert a DC voltage into an AC voltage;
at least two link circuit capacitors arranged in series on an input side in parallel with the half-bridge circuit; and
an auxiliary voltage generating unit configured to be supplied with electrical energy by a link circuit capacitor of the at least two link circuit capacitors and configured to generate an auxiliary DC voltage of less than or equal to 48 V.

2. The circuit arrangement of claim 1, wherein the half-bridge circuit has, in each branch of two branches, at least two switching elements arranged in series, and
wherein a flying capacitor is connected in parallel with respectively corresponding switching elements of the two branches.

3. The circuit arrangement of claim 2, wherein a voltage at the flying capacitor is controllable by a choice of switching times of the at least two switching elements.

4. The circuit arrangement of claim 3, wherein the auxiliary voltage generating unit comprises:
a full-bridge circuit,
a transformer supplied by the full-bridge circuit; and
a rectifier circuit supplied by the transformer.

5. A power converter comprising:
a circuit arrangement comprising:
a half-bridge circuit configured to output a load current and convert a DC voltage into an AC voltage;
at least two link circuit capacitors arranged in series on an input side in parallel with the half-bridge circuit; and
an auxiliary voltage generating unit configured to be supplied with electrical energy by a link circuit capacitor of the at least two link circuit capacitors and configured to generate an auxiliary DC voltage of less than or equal to 48 V.

6. The power converter of claim 5, wherein the power converter is an inverter.

7. A vehicle comprising:
a power converter for an electric or hybrid electric drive, the power converter comprising:
a circuit arrangement comprising:
a half-bridge circuit configured to output a load current and convert a DC voltage into an AC voltage;
at least two link circuit capacitors arranged in series on an input side in parallel with the half-bridge circuit; and
an auxiliary voltage generating unit configured to be supplied with electrical energy by a link circuit capacitor of the at least two link circuit capacitors and configured to generate an auxiliary DC voltage of less than or equal to 48 V.

8. The vehicle of claim 7, wherein the vehicle is an aircraft.

9. The vehicle of claim 8, further comprising:
an electric motor configured to be supplied with electrical energy by the power converter; and
a propeller configured to be set in rotation by the electric motor.

10. A method for generating an auxiliary DC voltage the method comprising:
outputting, by a half-bridge circuit, a load current and converting a DC voltage into an AC voltage; and
providing at least two link circuit capacitors arranged in series on an input side in parallel with the half-bridge circuit; and
supplying an auxiliary voltage generating unit with electrical energy from a link circuit capacitor of the at least two link circuit capacitors, wherein an auxiliary DC voltage of less than or equal to 48 V is generated.

11. The circuit arrangement of claim 1, wherein the auxiliary voltage generating unit comprises:
a full-bridge circuit;
a transformer supplied by the full-bridge circuit; and
a rectifier circuit supplied by the transformer.

12. The circuit arrangement of claim 2, wherein the auxiliary voltage generating unit comprises:
a full-bridge circuit;
a transformer supplied by the full-bridge circuit; and
a rectifier circuit supplied by the transformer.

13. The vehicle of claim 7, wherein the power converter is an inverter.
